(19) United States
(12) Patent Application Publication
(10) Pub. No.: US 2023/0096586 A1
(43) Pub. Date: Mar. 30, 2023

(54) REGION DIVISION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Jixuan CAI, Shenzhen (CN); Hong LIU, Shenzhen (CN); Yuhao SUN, Shenzhen (CN); Lingying ZENG, Shenzhen (CN)

(21) Appl. No.: 18/076,142

(22) Filed: Dec. 6, 2022

Related U.S. Application Data
(63) Continuation of application No. PCT/CN2021/102627, filed on Jun. 28, 2021.

(30) Foreign Application Priority Data
Sep. 21, 2020 (CN) 202010996622.X

(51) Int. Cl. G06Q 30/02

(52) U.S. Cl. CPC G06Q 30/0205

(57) ABSTRACT

A region division includes: determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants; determining business districts corresponding to the plurality of merchants based on the merchant relationship network; and determining a business district boundary of each business district according to the geographic information of the merchants included in each business district.

### RELATED APPLICATION(S)

This application is a continuation application of PCT Patent Application No. PCT/CN2021/102627 filed on Jun. 28, 2021, which claims priority to Chinese Patent Application No. 202010996622.X, entitled “REGION DIVISION METHOD AND APPARATUS, ELECTRONIC DEVICE, AND COMPUTER-READABLE STORAGE MEDIUM” filed on Sep. 21, 2020, all of which are incorporated by reference in entirety.

### FIELD OF THE TECHNOLOGY

The present disclosure relates to the field of Internet technologies, and in particular, to region division.

### BACKGROUND

With the advent of an electronic information age, Internet plays an increasingly important role in people's lives. People can obtain various kinds of information quickly and in real time through the Internet. Implementation of the Internet provides great convenience for people's lives and work, thus becoming a very popular technology at present.

When market expansion is performed on a certain region, it is often desirable to first analyze a specific commercial condition of the region, and divide business districts with relatively higher commercialization and popularity in the region, and some business districts can be selected to perform corresponding market expansion in a targeted manner, to improve sales of merchants and achieve a better expansion effect. The business district is a region where commercial activities occur frequently and intensively. It usually relies on cognition and experience of technicians for a certain region to manually divide a corresponding business district on a map of the certain region.

### SUMMARY

Embodiments of the present disclosure provide a region division method and apparatus, an electronic device, and a computer-readable storage medium, which can achieve a technical effect of automatically, efficiently and comprehensively dividing a business district in a target region, and can provide support for implementation scenarios such as commercial targeted promotion, increasing customer flow in a shopping mall, and the like.

In one aspect, the present disclosure provides a region division method. The region division method includes: determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants; determining business districts corresponding to the plurality of merchants based on the merchant relationship network; and determining a business district boundary of the business district according to the geographic information of the merchants included in the business district.

According to the method in the embodiments of the present disclosure, a corresponding business district and a more accurate business district boundary can be automatically generated based on a cloud server, which can effectively avoid errors in dividing the business district and determining business district boundary due to differences or deficiencies of technicians' personal cognition and experience, and achieve a technical effect of automatically, efficiently and comprehensively dividing a business district in a target region.

In another aspect, the present disclosure provides a region division apparatus. The region division apparatus includes: a memory storing computer program instructions; and a processor coupled to the memory and configured to execute the computer program instructions and perform: determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants; determining business districts corresponding to the plurality of merchants based on the merchant relationship network; and determining a business district boundary of the business district according to the geographic information of the merchants comprised in the business district.

In yet another aspect, the present disclosure provides a non-transitory computer-readable storage medium storing computer program instructions executable by at least one processor to perform: determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants; determining business districts corresponding to the plurality of merchants based on the merchant relationship network; and determining a business district boundary of the business district according to the geographic information of the merchants comprised in the business district.

According to the region division method provided in the embodiments of the present disclosure, a corresponding merchant relationship network can be automatically constructed according to geographic information of a plurality of merchants in a target region, which provides suitable prerequisites for automatically generating a business district and more accurately determining a business district boundary, so that a corresponding business district can be automatically generated according to the constructed merchant relationship network, and a more accurate business district boundary is automatically generated according to geographic information of merchants included in each business district. Therefore, errors in dividing the business district and determining business district boundary due to differences or deficiencies of technicians' personal cognition and experience are effectively avoided, and a technical effect of automatically, efficiently and comprehensively dividing a business district in a target region is achieved, which can provide support for implementation scenarios such as commercial targeted promotion and increasing customer flow in a shopping mall.

Additional aspects and advantages of the embodiments of the present disclosure are partially given in the following descriptions, and become apparent from the following descriptions or are learned from practices of the present disclosure.

Other aspects of the present disclosure can be understood by those skilled in the art in light of the description, the claims, and the drawings of the present disclosure.

### BRIEF DESCRIPTION OF THE DRAWINGS

To facilitate a better understanding of technical solutions of certain embodiments of the present disclosure, accompanying drawings are described below. The accompanying drawings are illustrative of certain embodiments of the present disclosure, and a person of ordinary skill in the art may still derive other drawings from these accompanying drawings without having to exert creative efforts. When the following descriptions are made with reference to the accompanying drawings, unless otherwise indicated, same numbers in different accompanying drawings may represent same or similar elements. In addition, the accompanying drawings are not necessarily drawn to scale.

FIG. 1 is a schematic flowchart of a region division method according to certain embodiment(s) of the present disclosure;

FIG. 2 is a schematic diagram of a network structure according to certain embodiment(s) of the present disclosure;

FIG. 3 is a schematic diagram of business district division according to certain embodiment(s) of the present disclosure;

FIG. 4 is a schematic diagram of a business district boundary according to certain embodiment(s) of the present disclosure;

FIG. 5 is a schematic structural diagram of a region division apparatus according to certain embodiment(s) of the present disclosure; and

FIG. 6 is a schematic structural diagram of an electronic device according to certain embodiment(s) of the present disclosure.

### DETAILED DESCRIPTION

To make objectives, technical solutions, and/or advantages of the present disclosure more comprehensible, certain embodiments of the present disclosure are further elaborated in detail with reference to the accompanying drawings. The embodiments as described are not to be construed as a limitation to the present disclosure. All other embodiments obtained by a person of ordinary skill in the art without creative efforts shall fall within the protection scope of embodiments of the present disclosure.

When and as applicable, the term “an embodiment,” “one embodiment,” “some embodiment(s), “some embodiments,” “certain embodiment(s),” or “certain embodiments” may refer to one or more subsets of all possible embodiments. When and as applicable, the term “an embodiment,” “one embodiment,” “some embodiment(s), “some embodiments,” “certain embodiment(s),” or “certain embodiments” may refer to the same subset or different subsets of all the possible embodiments, and can be combined with each other without conflict.

In certain embodiments, the term “based on” is employed herein interchangeably with the term “according to.”

A person skilled in the art may understand that, the singular forms “a”, “an”, “said”, and “the” used herein may include the plural forms as well, unless the context clearly indicates otherwise. It is to be further understood that, the terms “include” and/or “comprise” used in the present disclosure of the present disclosure refer to the presence of stated features, integers, steps, operations, elements, and/or components, but do not preclude the presence or addition of one or more other features, integers, steps, operations, elements, components, and/or combinations thereof. It is to be understood that, when an element is “connected” or “coupled” to another element, the element may be directly connected to or coupled to another element, or an intermediate element may exist. In addition, the “connection” or “coupling” used herein may include a wireless connection or a wireless coupling. The term “and/or” used herein includes all of or any of units and all combinations of one or more related listed items.

The term “and/or” in the embodiments of the present disclosure describes an association relationship for describing associated objects and represents that three relationships may exist. For example, A and/or B may represent the following three scenarios: Only A exists, both A and B exist, and only B exists. The character “/” generally indicates an “or” relationship between the associated objects. In the embodiments of the present disclosure, the term “multiple” means two or more, and another quantifier is similar to this.

To make objectives, technical solutions, and advantages of the embodiments of the present disclosure clearer, the following further describes in detail implementations of the present disclosure with reference to the accompanying drawings.

The following describes the technical solutions of the embodiments of the present disclosure and how to resolve the technical problems according to the technical solutions of the embodiments of the present disclosure in detail by using specific embodiments. The following several specific embodiments may be combined with each other, and a same or similar concept or process may not be described repeatedly in some embodiments. The following describes the embodiments of the present disclosure with reference to accompanying drawings.

In the embodiments of the present disclosure, a merchant relationship network of a target region is constructed for merchant information of a large number of merchants in the target region through cloud computing in a cloud technology. In addition, at least one business district corresponding to a plurality of merchants can be determined based on the merchant relationship network through the cloud computing, and a business district boundary of each business district can be determined according to geographic information of merchants included in each business district.

The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an implementation technology, and the like based on an implementation of a cloud computing business mode, and may form a resource pool, which is used as desired, and is flexible and convenient. A cloud computing technology will become an important support. A background service of a technical network system desires a large amount of computing and storage resources, such as a video website, an image website, and more portal websites. As the Internet industry is highly developed and applied, each article may have a respective ID in the future and may be transmitted to a background system for logical processing. Data at different levels is separately processed, and data in various industries desires strong system support, which can only be implemented through cloud computing.

Cloud computing is a computing mode, in which computing tasks are distributed on a resource pool formed by a large quantity of computers, so that various implementation systems can obtain computing power, storage space, and information services. A network that provides resources is referred to as a “cloud”. For a user, resources in a “cloud” seem to be infinitely expandable, and can be obtained readily, used on demand, expanded readily, and paid according to usage.

Cloud computing is a delivery and usage mode of IT infrastructures, which is to obtain desirable resources by using a network in an on-demand and easily expandable manner. Cloud computing in a broad sense is a delivery and usage mode of services, which is to obtain desirable services by using a network in an on-demand and easily expandable manner. Such services may be related to the IT, software, and the Internet, or may be other services. Cloud computing is a product of development and integration of suitable computer and network technologies such as grid computing, distributed computing, parallel computing, utility computing, network storage technologies, virtualization, load balance, and the like.

Cloud computing grows rapidly with development of Internet, real-time data streaming, diversity of connection devices, and demands for searching service, social network, mobile commerce, and open collaboration. Different from parallel distributed computing in the past, emergence of cloud computing will promote revolutionary changes in an entire Internet model and enterprise management model.

An embodiment of the present disclosure provides a region division method. The method is performed by a computing device. The computing device may be a terminal or a server. The terminal may be a desktop device or a mobile terminal. The server may be an independent physical server, a physical server cluster, or a virtual server.

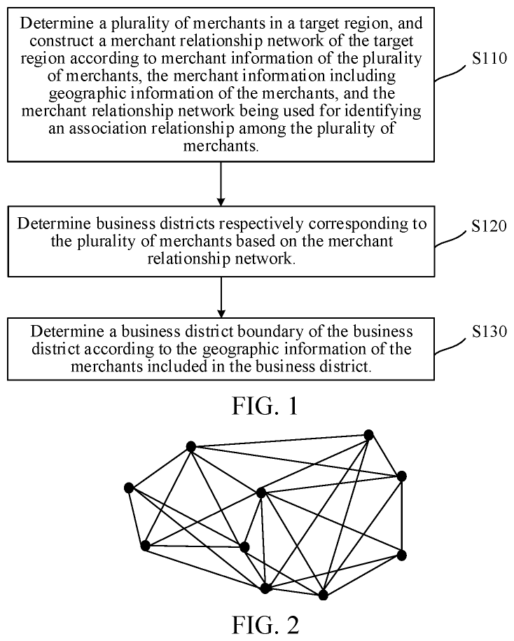

As shown in FIG. 1, the method includes: S110. Determine a plurality of merchants in a target region, and construct a merchant relationship network of the target region according to merchant information of the plurality of merchants, the merchant information including geographic information of the merchants, and the merchant relationship network being used for identifying an association relationship among the plurality of merchants. S120. Determine business districts respectively corresponding to the plurality of merchants based on the merchant relationship network. S130. Determine a business district boundary of the business district according to the geographic information of the merchants included in the business district.

The target region in the embodiments of the present disclosure may be any region in which the business district is to be divided, or may be a region in which the business district has been divided but may be divided again. The merchants in the embodiments of the present disclosure refer to merchants, stores, or shops with physical business premises, such as a hotel, a restaurant, a bar, a coffee shop, a beauty shop, a nail shop, a hairdresser, a bookstore, a fitness center, a pet shop, a supermarket, a cinema, and the like.

The business district in the embodiments of the present disclosure is usually a region where commercial activities occur frequently and are concentrated, for example, a region composed of commercial entities with high aggregation and strong synergy. The aggregation refers to dense distribution of commercial entities in the business district, in which the commercial entities can be basically reached on foot. The synergy means that a commodity or service in the business district can arouse a customer's interest in another commodity or service, and increase the customer's purchase intention.

In an example, according to the embodiments of the present disclosure, in a process of performing region division on the target region (that is, performing business district division on the target region), the following processing may be performed:

First, a plurality of merchants (for example, a merchant M_1, a merchant M_2, a merchant M_3, . . . , a merchant M_10) in the target region (for example, a target region D1 is a section of an A1 district in a city A) are determined. In a process of determining the plurality of merchants in the target region, besides geographic information of each merchant in the plurality of merchants in the target region, a quantity of the plurality of merchants in the target region, a business item operated by each merchant, and the like can further be determined. This is not limited in the embodiments of the present disclosure. After the plurality of merchants in the target region are determined, a merchant relationship network of the target region can be constructed according to the geographic information of each merchant in the plurality of merchants.

The merchant relationship network may be a network structure shown in FIG. 2. In FIG. 2, each merchant is equivalent to a node in the merchant relationship network (that is, a black dot in FIG. 2), and a whole merchant relationship network is formed by the merchants through a mutual-attention relationship. In the merchant relationship network, some merchants are closely connected, while others are sparsely connected. A closely connected part can be regarded as a community (that is, the business district), and its internal nodes are closely connected, while two communities are relatively sparsely connected.

Based on the constructed merchant relationship network, at least one business district corresponding to the plurality of merchants in the target region is determined. That is, division of the business district is performed on the plurality of merchants in the target region according to the constructed merchant relationship network.

In an implementation scenario, if the plurality of merchants in the target region are a merchant M_1, a merchant M_2, a merchant M_3, . . . , and a merchant M_10, that is, the merchant M_1, the merchant M_2, the merchant M_3, . . . , and the merchant M_10 constitute a merchant relationship network. In the merchant relationship network, if the merchant M_1, the merchant M_2, and the merchant M_7 are closely connected, the merchant M_1, the merchant M_2, and the merchant M_7 can be divided into one business district (which is denoted as a business district T1). If the merchant M_3, the merchant M_6, the merchant M_9, and the merchant M_10 are closely connected, the merchant M_3, the merchant M_6, the merchant M_9, and the merchant M_10 can be divided into one business district (which is denoted as a business district T2). If the merchant M_4, the merchant M_5, and the merchant M_8 are closely connected, the merchant M_4, the merchant M_5, and the merchant M_8 can be divided into one business district (which is denoted as a business district T3). In this example, ten merchants in the target region are divided into three business districts.

A business district boundary of each business district is determined according to the geographic information of the merchants included in each business district. Using the three business districts (the business district T1, the business district T2, and the business district T3) in the example as an example, for each of the three business districts, such as the business district T1, a business district boundary of the business district T1 can be determined according to geographic information of merchants (that is, the merchant M_1, the merchant M_2, and the merchant M_7) included in the business district T1, to more accurately and reasonably determine a regional scope of the business district (that is, a geographical region within the business district boundary).

According to the method provided in the embodiments of the present disclosure, a corresponding merchant relationship network can be automatically constructed according to merchant information of a plurality of merchants in a target region, which provides suitable prerequisites for automatically generating a business district and more accurately determining a business district boundary, so that a corresponding business district can be automatically generated according to the constructed merchant relationship network, and a more accurate business district boundary is automatically generated according to geographic information of merchants included in each business district. Therefore, errors in dividing the business district and determining business district boundary due to differences or deficiencies of technicians' personal cognition and experience are effectively avoided, and a technical effect of automatically, efficiently and comprehensively dividing a business district in a target region is achieved, which can provide support for implementation scenarios such as commercial targeted promotion and increasing customer flow in a shopping mall.

Using an example in which the target region D1 is the section of the A1 district of city A, and the plurality of merchants are respectively the merchant M_1, the merchant M_2, the merchant M_3, . . . , and the merchant M_10, several implementations of the embodiments of the present disclosure are described as follows:

In certain embodiment(s), the merchant information further includes transaction information. In a process of constructing a merchant relationship network of the target region according to merchant information of the plurality of merchants, the following processing may be performed: First, a network weight between any two merchants in the plurality of merchants is determined according to the geographic information and the transaction information of the plurality of merchants, the network weight representing a closeness degree of an association relationship between the two merchants. The merchant relationship network of the target region is constructed based on the network weight.

In a process of determining a plurality of merchants (that is, the merchant M_1, the merchant M_2, the merchant M_3, . . . and the merchant M_10) in the target region D1, besides geographic information of the merchant M_1, the merchant M_2, the merchant M_3, . . . , and the merchant M_10 in the target region, it is also desirable to obtain transaction information of the merchant M_1, the merchant M_2, the merchant M_3, . . . , and the merchant M_10, to more accurately construct the merchant relationship network according to the geographic information and the transaction information.

After the transaction information of the merchant M_1, the merchant M_2, the merchant M_3, . . . , and the merchant M_10 in the target region D1 is obtained, a network weight representing a closeness degree of an association relationship between each two merchants in the merchant M_1, the merchant M_2, the merchant M_3, . . . , and the merchant M_10 can be determined according to the geographic information and the transaction information of the merchant M_1, the merchant M_2, the merchant M_3, . . . , and the merchant M_10. That is, a network weight between the merchant M_1 and the merchant M_2 (denoted as a network weight P_1_2), a network weight between the merchant M_1 and the merchant M_3 (denoted as a network weight P_1_3), a network weight between the merchant M_2 and the merchant M_3 (denoted as a network weight P_2_3), . . . , and a network weight between the merchant M_9 and the merchant M_10 (denoted as a network weight P_9_10) are sequentially determined. Using the network weight P_1_2 as an example, the network weight P_1_2 represents a closeness degree of an association relationship between the merchant M_1 and the merchant M_2. For example, the larger the network weight P_1_2 is, the closer the association relationship between the merchant M_1 and the merchant M_2 is, and the smaller the network weight P_1_2 is, the sparser the association relationship between the merchant M_1 and the merchant M_2 is.

After network weights between each two merchants of the merchant M_1, the merchant M_2, the merchant M_3, . . . , and the merchant M_10 are determined, in a process of constructing the merchant relationship network, the merchant M_1, the merchant M_2, the merchant M_3, . . . , and the merchant M_10 may be regarded as nodes in the merchant relationship network. That is, the merchant M_1 may be regarded as a node in the merchant relationship network, the merchant M_2 may be regarded as another node in the merchant relationship network, . . . , and the merchant M_10 may be regarded as another node in the merchant relationship network. In addition, the network weight between each two merchants is regarded as an edge in the merchant relationship network. In a process of constructing a network, a corresponding network can be constructed naturally as long as a node in the network and an edge of the network are determined. Therefore, a corresponding merchant relationship network can be directly constructed after a node in the merchant relationship network and an edge of the merchant relationship network are determined.

In certain embodiment(s), the transaction information includes transaction time. In a process of determining a network weight between any two merchants in the plurality of merchants according to the geographic information and the transaction information of the plurality of merchants, the following processing may be performed: First, a first weight between the any two merchants is calculated according to a distance between the any two merchants, the first weight representing an aggregation condition between the two merchants, and the distance being calculated according to the geographic information of the merchants. A second weight between the any two merchants is calculated according to a transaction time difference of a same user performing transaction with the any two merchants, the second weight representing a synergy condition between the two merchants. The network weight between the any two merchants is determined according to the first weight and the second weight.

Generally, the edge (that is, the network weight) of the merchant relationship network is measured through two aspects of information: an aggregation condition of the merchants, and a synergy condition of the merchants. The aggregation condition of the merchants refers to dense distribution of the merchants in the business district, and a distance between merchants is basically within a distance that can be basically reached on foot. The synergy condition of the merchants refers to a condition in which a commodity and/or service of a merchant can arouse a customer's interest in a commodity and/or service of another merchant in the business district.

Based on this, in a process of determining the edge of the merchant relationship network (that is, the network weight), according to geographic information of each two merchants, a distance between the each two merchants can be determined. According to a predetermined distance and the distance between the each two merchants, a first weight between the each two merchants representing an aggregation condition between the each two merchants is calculated, that is, information affecting an aspect of the network weight is determined. The predetermined distance may be dynamically set according to development degrees of different regions, forms or economic development conditions of different cities, topography and geomorphology of different regions, and the like. For example, if a region (such as a region L1) is economically backward, or has a low population density, or belongs to a mountainous region, a large predetermined distance may be set for the region, such as 5 km (kilometer), 8 km, and the like. In another example, if a region (such as a region L2) is economically developed, or has a high population density, or belongs to a plain region, a small predetermined distance may be set for the region, such as 2 km, 3 km, and the like.

In an example, the first weight between each two merchants may be calculated according to the predetermined distance and the distance between each two merchants based on the following formula:

$${G}_{i j} = \{ \begin{matrix}{( 1 - \frac{{( Δ {d}_{i j} )}^{2}}{{( Δ {d}_{max} )}^{2}} )}^{2} , & Δ {d}_{i j} \leq Δ {d}_{max} \\ 0 , & otherwise\end{matrix}$$

Gᵢⱼ represents a first weight between a merchant i and a merchant j, and represents an aggregation condition between the merchant i and the merchant j. The larger Gᵢⱼ is, the closer the aggregation condition between the merchant i and the merchant j is. Δdᵢⱼ represents a distance between the merchant i and the merchant j. Δdₘₐₓ is a predetermined distance, such as 2 km. According to the formula, it can be seen that if the distance between each two merchants is smaller, the first weight is larger.

In addition, in the process of determining the edge of the merchant relationship network (that is, the network weight), a second weight between each two merchants representing a synergy condition between each two merchants can be calculated according to a predetermined duration and a transaction time difference of a same user performing transaction with the each two merchants, that is, information affecting another aspect of the network weight is determined. The predetermined duration may be dynamically set according to population density of different regions. For example, if population density of a region (such as the region L1) is relatively low, a large predetermined duration may be set for the region, such as 5 hours, 8 hours, and the like. In another example, if population density of a region (such as the region L2) is relatively high, a small predetermined duration may be set for the region, such as 1 hour, 2 hours, 3 hours, and the like.

In an example, the second weight between each two merchants may be calculated according to the predetermined duration and the transaction time difference of the same user performing transaction with the each two merchants, based on the following formula:

$${S}_{i j} = {\sum }_{u ∈ u ( i ) ⋂ u ( j )} f ( Δ {t}_{u i , u j} )$$

$$f ( Δ {t}_{u i , u j} ) = \{ \begin{matrix}{( 1 - \frac{{( Δ {t}_{u i , u j} )}^{2}}{{( Δ {t}_{max} )}^{2}} )}^{2} , & Δ {t}_{u i , u j} \leq Δ {t}_{max} \\ 0 , & otherwise\end{matrix}$$

Sᵢⱼ represents a second weight between a merchant i and a merchant j, and represents a synergy condition between the merchant i and the merchant j. The larger Sᵢⱼ is, the better the synergy condition between the merchant i and the merchant j is. u ∈ u(i) ∩ u(j) represents a common customer (that is, the user) of the merchant i and the merchant j. Δt_{ui,uj} is a transaction time difference of the same user performing transaction with the merchant i and the merchant j. For example, transaction time of a customer U1 performing transaction with the merchant i is T1, and transaction time of the customer U1 performing transaction with the merchant j is T2, a transaction time difference of the customer U1 performing transaction with the merchant i and the merchant j is T1-T2 or T2-T1. Δtₘₐₓ is a predetermined duration, such as 2 hours.

According to the formula, it can be seen that if the transaction time difference of the same user performing transaction with each two merchants is smaller, the second weight is larger. That is, f(Δt_{ui,uj}) is a time decay function. When the transaction time difference between two transactions exceeds Δtₘₐₓ, it can be considered that a synergy condition between two merchants can be ignored.

After the first weight and the second weight are determined, the network weight between each two merchants can be determined according to the first weight and the second weight, so that the merchant relationship network can be constructed according to the network weight. In this implementation, related parameters such as the predetermined distance and the predetermined time of each region are objectively determined according to a condition in each region, which achieves adaptive adjustment of the related parameters such as the predetermined distance and the predetermined time, and overcomes influence of differences in different regions on an algorithm of constructing the merchant relationship network, so that an appropriate business district scope of each region can be generated without too much manual intervention.

In a process of determining the network weight between each two merchants according to the first weight and the second weight, the network weight between each two merchants can be obtained by calculating a product of the first weight and the second weight and determining the product as the network weight between each two merchants. Based on the example, a network weight Aᵢⱼ between the merchant i and the merchant j can be expressed as: Aᵢⱼ=Gᵢⱼ×S. Gᵢⱼ is the first weight between the merchant i and the merchant j, and Sᵢⱼ is the second weight between the merchant i and the merchant j.

The merchant i and the merchant j are merely used as an example in the description. For another merchant in the target region, the network weight between each two merchants can be calculated in a similar manner as described above, and details are not repeated herein.

In certain embodiment(s), in a process of determining at least one business district corresponding to a plurality of merchants based on the merchant relationship network, business districts respectively corresponding to the plurality of merchants can be determined through a modularity-based community detection algorithm, and based on the merchant relationship network.

The modularity-based community detection algorithm uses modularity to measure quality of community (that is, business district scope) division. Simply speaking, nodes (that is, the merchants) with a dense connection are divided into one community, so that a value of the modularity becomes larger, and final division with largest modularity is an adjusted community division, that is, a target of the modularity-based community detection algorithm is to maximize the modularity. Generally, a target of the community division is to make a connection within a divided community closer, while a connection between communities is sparse. An advantage and disadvantage of such division can be described by the modularity. The larger the modularity is, the better an effect of the community division is. A formula for calculating the modularity is as follows:

$$Q = \frac{1}{2 m} {\sum }_{i , j} [ {A}_{i j} - \frac{{k}_{i} {k}_{j}}{2 m} ] δ ( {c}_{i} , {c}_{j} )$$

Q is the modularity, m=½Σ_{i,j}Aᵢⱼ represents a sum of weights of all edges in a network (that is, the merchant relationship network), Aᵢⱼ is a weight (that is, the network weight) between a node i (that is, the merchant i) and a node j (that is, the merchant j) in the network, kᵢ=ΣⱼAᵢⱼ represents a weight of an edge connected to a vertex i, and similarly, kⱼ=ΣᵢAᵢⱼ represents a weight of an edge connected to a vertex j. cᵢ represents a community to which the vertex i is assigned, cⱼ represents a community to which the vertex j is assigned, and δ(cᵢ, cⱼ) is used for determining whether the vertex i and the vertex j are divided into the same community. If the vertex i and the vertex j are divided into the same community, 1 is returned, otherwise 0 is returned.

According to the formula, it can be seen that the modularity refers to an expected value of proportion of an edge connecting vertices in the network minus proportion of an edge arbitrarily connecting these two nodes under the same network.

Fast Unfolding algorithm is an algorithm of community detection based on modularity, and the Fast Unfolding algorithm is an iterative algorithm, whose main goal is to continuously divide a community, so that modularity of an entire divided network continuously increases. A calculation process of the Fast Unfolding algorithm is:

S1. Regard each node in the network as an independent community, so that a quantity of communities is the same as a quantity of nodes.

S2. For each node i, try to assign the node i to a community where each of its neighbor nodes is located, calculate a modularity change value (denoted as ΔQ) of a community where each of the neighbor nodes of the node i is located before and after the node i is assigned to the community where each of its neighbor nodes is located, record a neighbor node corresponding to a maximum value of ΔQ, and if the maximum value of ΔQ is greater than 0, assign the node i to the community where the neighbor node corresponding to the maximum value of ΔQ is located, otherwise remain unchanged.

S3. Perform S2 repeatedly until communities to which all nodes belong do not change.

S4. Compress the network, compress all nodes in the same community into a new node, convert a weight of an edge between nodes in the community into a weight of a ring of the new nodes, and convert a weight of an edge between communities into a weight of an edge between the new nodes.

S5. Perform step S1 until modularity of an entire network is no longer changed.

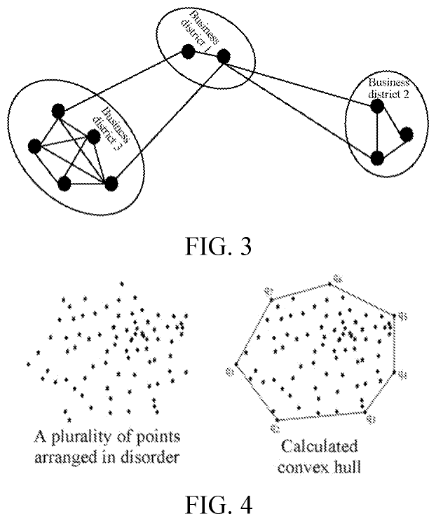

In the S4, a community divided in S3 is aggregated into a new node (one community corresponds to one new node), a subnetwork is reconstructed, and a weight of an edge between two new nodes is a sum of weights of each edge between corresponding two communities. As shown in FIG. 3, if there are three communities obtained through S3 in FIG. 3, these three communities can be respectively regarded as a new node, and a sum obtained by adding weights of all connecting lines (that is, edges) between any two new nodes is used as a weight of connecting lines between the two nodes. Each black dot in FIG. 3 represents a merchant.

When the node i is assigned to a community c where a neighbor node j is located, a modularity change value ΔQ is:

$$Δ Q = [ \frac{{Σ}_{i n} + {k}_{i , i n}}{2 m} - {( \frac{{Σ}_{t o t} + {k}_{i}}{2 m} )}^{2} ] - [ \frac{{Σ}_{i n}}{2 m} - {( \frac{{Σ}_{t o t}}{2 m} )}^{2} - {( \frac{{k}_{i}}{2 m} )}^{2} ]$$

Σᵢₙ is a sum of the weights of edges in the community c. If it is in an initial condition, that is, when one node is used as one community, it is a connection of the node itself to itself. In this scenario, a starting point and an end point are desirable to add weight (even if the starting point and the end point are the same node in this scenario). Σₜₒₜ is a sum of weights of edges associated to nodes in c. kᵢ is a sum of weights of edges associated to the node i. k_{i,in} is a sum of weights of edges of nodes connected to the node i in the community c. m is a sum of weights of all edges in the network.

This implementation, through the modularity-based community detection algorithm, is easy to implement, is unsupervised and fast in calculation, has inherent multi-level characteristics, and can quickly and more accurately determine business districts corresponding to a plurality of merchants in the merchant relationship network.

In certain embodiment(s), in a process of determining a business district boundary of the business district according to the geographic information of the merchants included in the business district, the following processing may be performed: First, the business district is trimmed according to the geographic information of the merchants included in the business district, to eliminate a marginal merchant in the business district. A convex hull of the trimmed business district is determined according to geographic information of merchants included in the trimmed business district, and the business district boundary of the business district is determined according to the convex hull.

Because the business district is surrounded by a plurality of merchants, and a marginal scattered merchant has a relatively great impact on a scope of the business district, it is desirable to eliminate the marginal scattered merchant (that is, the marginal merchant) from the business district, to obtain a more accurately-divided business district. In a process of eliminating, the marginal scattered merchant can be determined according to geographic information of merchants included in each business district, so that the marginal scattered merchant can be eliminated from the scope of the business district, that is, the business district is trimmed to obtain a trimmed business district. After the trimmed business district is obtained, the convex hull (that is, a convex polygon) of the trimmed business district can be determined according to geographic information of merchants included in the trimmed business district, to determine a business district boundary of each business district according to the convex hull. For example, the obtained convex hull is directly used as the business district boundary, that is, a regional scope covered by the convex hull is the regional scope of the business district.

Usually, in a two-dimensional coordinate system, there are a plurality of points arranged in disorder, and outermost points are connected to form a convex polygon, which can include all the given points. This polygon is a convex hull. As shown in FIG. 4, a left side of FIG. 4 is a plurality of points arranged in disorder in the two-dimensional coordinate system, and a right side of FIG. 4 is a convex hull calculated according to the geographic information of the merchants (that is, a plurality of points in FIG. 4) included in the trimmed business district based on a predetermined convex hull calculation method, and a final business district boundary can be obtained after the convex hull is calculated.

In certain embodiment(s), the geographic information includes longitude information and latitude information. In a process of trimming the business district according to the geographic information of the merchants included in the business district, the following processing may be performed: First, based on a pre-trained isolation forest, outliers of merchants included in the business district are calculated according to the longitude information and latitude information of the merchants included in the business district. The marginal merchant is determined from the merchants of the business district according to the outliers, and the marginal merchant is eliminated from the business district in which it is located. The pre-trained isolation forest is obtained by pre-training according to longitude information and latitude information of sample merchants included in a sample business district. That is, an isolation forest algorithm can be used for calculating the outliers of the merchants included in the business district based on longitude information and latitude information of each merchant included in the business district, and a merchant in the business district is eliminated according to the calculated outliers.

The marginal merchant of the business district is a discrete merchant at an edge of the business district. In a process of eliminating the discrete merchant at the edge of the business district (that is, the marginal merchant) according to the pre-trained isolation forest, the following calculation formula can be used for calculating the outliers of the merchants included in the business district s(i):

$$s ( i ) = {2}^{- \frac{E ( h ( i ) )}{c ( n )}}$$

i represents a serial number of a merchant. For example, a serial number of a merchant 1 is 1, a serial number of a merchant 2 is 2, a serial number of a merchant i is i, and n is a quantity of all merchants in the business district in which the merchant i is located. A trained isolation forest includes a plurality of decision trees, and an average length of path between the merchant i and a root node in all decision trees is Σ(h(i)). c(n) is used for standardizing an impact of the quantity of the merchants included in the business district.

$$c ( n ) = 2 ln ( n - 1 ) - \frac{2 ( n - 1 )}{n}$$

ln(*) is a logarithmic function.

After an outlier s(i) of the merchant included in the business district is calculated, the discrete merchant at the edge of the business district can be eliminated according to the outlier s(i). In a process of eliminating the discrete merchant at the edge of the business district according to the outlier s(i), a merchant whose outlier is greater than a predetermined threshold can be determined as the discrete merchant (that is, the marginal merchant) at the edge of the business district, and eliminated from the business district, thereby ensuring that the trimmed business district is closer to a real scope.

In certain embodiment(s), a range of s(i) is a value between 0 and 1. When s(i) approaches 1, it is determined that the merchant i is an abnormal merchant (that is, the discrete merchant at the edge of the business district). In an example, a merchant with s(i) greater than 0.9 is regarded as the discrete merchant, and may be eliminated from a business district to which it belongs. That is, the discrete merchant at the edge of the business district is eliminated from the business district.

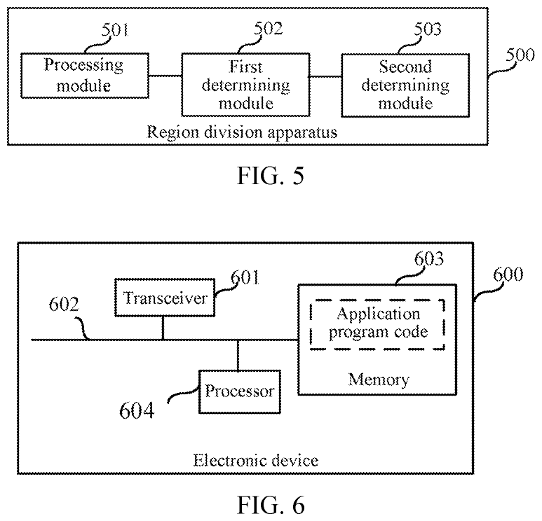

FIG. 5 is a schematic structural diagram of a region division apparatus according to another embodiment of the present disclosure. As shown in FIG. 5, an apparatus 500 may include: a processing module 501, a first determining module 502, and a second determining module 503.

The processing module 501 is configured to determine a plurality of merchants in a target region, and construct a merchant relationship network of the target region according to merchant information of the plurality of merchants, the merchant information including geographic information of the merchants, and the merchant relationship network being used for identifying an association relationship among the plurality of merchants.

The first determining module 502 is configured to determine business districts respectively corresponding to the plurality of merchants based on the merchant relationship network.

The second determining module 503 is configured to determine a business district boundary of the business district according to the geographic information of the merchants included in the business district.

In certain embodiment(s), the merchant information further includes transaction information. The processing module is configured to: determine a network weight between any two merchants in the plurality of merchants according to the geographic information and the transaction information of the plurality of merchants, the network weight representing a closeness degree of an association relationship between the two merchants; and construct the merchant relationship network of the target region based on the network weight.

In certain embodiment(s), the transaction information includes transaction time. The processing module is configured to: calculate a first weight between the any two merchants according to a distance between the any two merchants, the first weight representing an aggregation condition between the two merchants, and the distance being calculated according to the geographic information of the merchants; calculate a second weight between the any two merchants according to a transaction time difference of a same user performing transaction with the any two merchants, the second weight representing a synergy condition between the two merchants; and determine the network weight between the any two merchants according to the first weight and the second weight.

In certain embodiment(s), the processing module is configured to: calculate a product of the first weight and the second weight, and determine the product as the network weight between the any two merchants.

In certain embodiment(s), the first determining module is configured to determine, through a modularity-based community detection algorithm, the business districts respectively corresponding to the plurality of merchants based on the merchant relationship network.

In certain embodiment(s), the second determining module is configured to: trim the business district according to the geographic information of the merchants included in the business district, to eliminate a marginal merchant in the business district; and determine a convex hull of the trimmed business district according to geographic information of merchants included in the trimmed business district, and determine the business district boundary of the business district according to the convex hull.

In certain embodiment(s), the geographic information includes longitude information and latitude information. The second determining module is configured to: calculate, based on a pre-trained isolation forest, outliers of merchants included in the business district according to the longitude information and latitude information of the merchants included in the business district, the pre-trained isolation forest being obtained by pre-training according to longitude information and latitude information of sample merchants included in a sample business district; and determine the marginal merchant from the merchants of the business district according to the outliers, and eliminate the marginal merchant from the business district in which it is located.

In certain embodiment(s), the second determining module is configured to determine a merchant whose outlier is greater than a predetermined threshold in the business district as the marginal merchant.

According to the apparatus provided in the embodiments of the present disclosure, a corresponding merchant relationship network can be automatically constructed according to merchant information of a plurality of merchants in a target region, which provides desirable prerequisites for automatically generating a business district and more accurately determining a business district boundary, so that a corresponding business district can be automatically generated according to the constructed merchant relationship network, and a more accurate business district boundary is automatically generated according to geographic information of merchants included in each business district. Therefore, errors in dividing the business district and determining business district boundary due to differences or deficiencies of technicians' personal cognition and experience are effectively avoided, and a technical effect of automatically, efficiently and comprehensively dividing a business district in a target region is achieved, which can provide support for implementation scenarios such as commercial targeted promotion and increasing customer flow in a shopping mall.

This embodiment is an apparatus embodiment corresponding to the method embodiment, and this embodiment may be implemented in combination with the method embodiment. Related technical details mentioned in the method embodiment are still valid in this embodiment, and to reduce repetition, details are not described herein again. Correspondingly, related technical details mentioned in this embodiment may also be applied to the method embodiment.

As shown in FIG. 6, another embodiment of the present disclosure provides an electronic device. An electronic device 600 shown in FIG. 6 includes: a processor 601 and a memory 603. The processor 601 and the memory 603 are connected, for example, are connected by using a bus 602. Further, the electronic device 600 may further include a transceiver 604. During implementation, there may be one or more transceivers 604. The structure of the electronic device 600 does not constitute a limitation on this embodiment of the present disclosure.

The processor 601 is applied to the embodiments of the present disclosure, to implement functions of the processing module, the first determining module, and the second determining module shown in FIG. 5. The transceiver 604 includes a receiver and a transmitter.

The processor 601 may be a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or perform various examples of logic blocks, modules, and circuits described with reference to content disclosed in the present disclosure. The processor 601 may be alternatively a combination to implement a computing function, for example, may be a combination of one or more microprocessors, or a combination of a DSP and a microprocessor.

The bus 602 may include a channel, to transmit information between the components. The bus 602 may be a PCI bus, an EISA bus, or the like. The bus 602 may be classified into an address bus, a data bus, a control bus, and the like. For ease of description, the bus in FIG. 6 is represented by using only one bold line, but which it does not indicate that there is only one bus or one type of bus.

The memory 603 may be a ROM or another type of static storage device that can store static information and a static instruction; or a RAM or another type of dynamic storage device that can store information and an instruction; or may be an EEPROM, a CD-ROM or another compact-disc storage medium, optical disc storage medium (including a compact disc, a laser disk, an optical disc, a digital versatile disc, a Blu-ray disc, or the like) and magnetic disk storage medium, another magnetic storage device, or any other medium that can be configured to carry or store expected program code in a form of an instruction or a data structure and that is accessible by a computer, but is not limited thereto.

The memory 603 is configured to store application program code for performing the solutions of the present disclosure, and is controlled and executed by the processor 601. The processor 601 is configured to execute the application program code stored in the memory 603, to implement the actions of the region division apparatus provided in the embodiment shown in FIG. 5.

The electronic device provided in the embodiments of the present disclosure includes a memory, a processor, and a computer program stored on the memory and executable by the processor. The processor, when executing the program, implements: determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants; determining at least one business district corresponding to the plurality of merchants based on the merchant relationship network; and determining a business district boundary of the business district according to the geographic information of the merchants included in the business district.

An embodiment of the present disclosure provides a computer program product or a computer program. The computer program product or the computer program includes a computer instruction. The computer instruction is stored in a computer-readable storage medium. A processor of a computing device reads the computer instructions from the computer-readable storage medium, and executes the computer instructions, so that the computing device performs methods provided in the optional implementations in the region division aspect.

An embodiment of the present disclosure provides a computer-readable storage medium, storing a computer program, the program, when executed by a processor, causing the processor to implement the method according to the embodiments. A corresponding merchant relationship network can be automatically constructed according to merchant information of a plurality of merchants in a target region, which provides suitable prerequisites for automatically generating a business district and more accurately determining a business district boundary, so that a corresponding business district can be automatically generated according to the constructed merchant relationship network, and a more accurate business district boundary is automatically generated according to geographic information of merchants included in each business district. Therefore, errors in dividing the business district and determining business district boundary due to differences or deficiencies of technicians' personal cognition and experience are effectively avoided, and a technical effect of automatically, efficiently and comprehensively dividing a business district in a target region is achieved, which can provide support for implementation scenarios such as commercial targeted promotion and increasing customer flow in a shopping mall.

The computer-readable storage medium provided in this embodiment of the present disclosure is applied to any embodiment of the method.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

An embodiment of the present disclosure further provides a computer program product including instructions. When the computer program product runs on a computer, the computer is caused to perform the methods provided in the embodiments.

It is to be understood that, although the steps in the flowchart in the accompanying drawings are sequentially shown according to indication of an arrow, the steps are not necessarily sequentially performed according to a sequence indicated by the arrow. Unless explicitly specified in the present disclosure, execution of the steps is not strictly limited in the sequence, and the steps may be performed in other sequences. In addition, at least some steps in the flowcharts in the accompanying drawings may include a plurality of substeps or a plurality of stages. The substeps or the stages are not necessarily performed at the same moment, but may be performed at different moments. The substeps or the stages are not necessarily performed in sequence, but may be performed in turn or alternately with another step or at least some of substeps or stages of the another step.

The descriptions are some implementations of the present disclosure. A person of ordinary skill in the art may make several improvements and refinements without departing from the principle of the present disclosure, and the improvements and refinements shall fall within the protection scope of the present disclosure.

What is claimed is:

1. A region division method, performed by a computing device, the method comprising:
determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants;
determining business districts corresponding to the plurality of merchants based on the merchant relationship network; and
determining a business district boundary of the business district according to the geographic information of the merchants comprised in the business district.

2. The method according to claim 1, wherein the merchant information includes transaction information; and constructing the merchant relationship network comprises:
determining a network weight between any two merchants in the plurality of merchants according to the geographic information and the transaction information of the plurality of merchants, the network weight representing a closeness degree of an association relationship between the two merchants; and
constructing the merchant relationship network of the target region based on the network weight.

3. The method according to claim 2, wherein the transaction information includes transaction time, and determining the network weight comprises:
calculating a first weight between the any two merchants according to a distance between the any two merchants, the first weight representing an aggregation condition between the two merchants, and the distance being calculated according to the geographic information of the merchants;
calculating a second weight between the any two merchants according to a transaction time difference of a same user performing transaction with the any two merchants, the second weight representing a synergy condition between the two merchants; and
determining the network weight between the any two merchants according to the first weight and the second weight.

4. The method according to claim 3, wherein determining the network weight comprises:
calculating a product of the first weight and the second weight, and determining the product as the network weight between the any two merchants.

5. The method according to claim 1, wherein determining the business districts comprises:
determining, through a modularity-based community detection algorithm, the business districts respectively corresponding to the plurality of merchants based on the merchant relationship network.

6. The method according to claim 1, wherein determining the business district boundary comprises:
trimming the business district according to the geographic information of the merchants comprised in the business district, to eliminate a marginal merchant in the business district; and
determining a convex hull of the trimmed business district according to geographic information of merchants comprised in the trimmed business district, and determining the business district boundary of the business district according to the convex hull.

7. The method according to claim 6, wherein the geographic information includes longitude information and latitude information; and trimming the business district comprises:
calculating, based on a pre-trained isolation forest, outliers of merchants included in the business district according to the longitude information and latitude information of the merchants comprised in the business district, the pre-trained isolation forest being obtained by pre-training according to longitude information and latitude information of sample merchants comprised in a sample business district; and
determining the marginal merchant from the merchants of the business district according to the outliers, and eliminating the marginal merchant from the business district in which it is located.

8. The method according to claim 7, wherein determining the marginal merchant comprises:
determining a merchant whose outlier is greater than a predetermined threshold in the business district as the marginal merchant.

9. A region division apparatus, comprising: a memory storing computer program instructions; and a processor coupled to the memory and configured to execute the computer program instructions and perform:
determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants;
determining business districts corresponding to the plurality of merchants based on the merchant relationship network; and
determining a business district boundary of the business district according to the geographic information of the merchants comprised in the business district.

10. The region division apparatus according to claim 9, wherein the merchant information includes transaction information; and constructing the merchant relationship network includes:
determining a network weight between any two merchants in the plurality of merchants according to the geographic information and the transaction information of the plurality of merchants, the network weight representing a closeness degree of an association relationship between the two merchants; and
constructing the merchant relationship network of the target region based on the network weight.

11. The region division apparatus according to claim 10, wherein the transaction information includes transaction time, and determining the network weight includes:
calculating a first weight between the any two merchants according to a distance between the any two merchants, the first weight representing an aggregation condition between the two merchants, and the distance being calculated according to the geographic information of the merchants;
calculating a second weight between the any two merchants according to a transaction time difference of a same user performing transaction with the any two merchants, the second weight representing a synergy condition between the two merchants; and
determining the network weight between the any two merchants according to the first weight and the second weight.

12. The region division apparatus according to claim 11, wherein determining the network weight includes:
calculating a product of the first weight and the second weight, and determining the product as the network weight between the any two merchants.

13. The region division apparatus according to claim 9, wherein determining the business districts includes:
determining, through a modularity-based community detection algorithm, the business districts respectively corresponding to the plurality of merchants based on the merchant relationship network.

14. The region division apparatus according to claim 9, wherein determining the business district boundary includes:
trimming the business district according to the geographic information of the merchants comprised in the business district, to eliminate a marginal merchant in the business district; and
determining a convex hull of the trimmed business district according to geographic information of merchants comprised in the trimmed business district, and determining the business district boundary of the business district according to the convex hull.

15. The region division apparatus according to claim 14, wherein the geographic information includes longitude information and latitude information, and trimming the business district includes:
calculating, based on a pre-trained isolation forest, outliers of merchants included in the business district according to the longitude information and latitude information of the merchants comprised in the business district, the pre-trained isolation forest being obtained by pre-training according to longitude information and latitude information of sample merchants comprised in a sample business district; and
determining the marginal merchant from the merchants of the business district according to the outliers, and eliminating the marginal merchant from the business district in which it is located.

16. The region division apparatus according to claim 15, wherein determining the marginal merchant includes:
determining a merchant whose outlier is greater than a predetermined threshold in the business district as the marginal merchant.

17. A non-transitory computer-readable storage medium storing computer program instructions executable by at least one processor to perform:
determining a plurality of merchants in a target region, and constructing a merchant relationship network of the target region according to merchant information of the plurality of merchants, the merchant information including geographic information of the merchants, and the merchant relationship network being used for identifying an association relationship among the plurality of merchants;
determining business districts corresponding to the plurality of merchants based on the merchant relationship network; and
determining a business district boundary of the business district according to the geographic information of the merchants comprised in the business district.

18. The non-transitory computer-readable storage medium according to claim 17, wherein the merchant information includes transaction information; and constructing the merchant relationship network includes:
determining a network weight between any two merchants in the plurality of merchants according to the geographic information and the transaction information of the plurality of merchants, the network weight representing a closeness degree of an association relationship between the two merchants; and
constructing the merchant relationship network of the target region based on the network weight.

19. The non-transitory computer-readable storage medium according to claim 18, wherein the transaction information includes transaction time, and determining the network weight includes:
calculating a first weight between the any two merchants according to a distance between the any two merchants, the first weight representing an aggregation condition between the two merchants, and the distance being calculated according to the geographic information of the merchants;
calculating a second weight between the any two merchants according to a transaction time difference of a same user performing transaction with the any two merchants, the second weight representing a synergy condition between the two merchants; and
determining the network weight between the any two merchants according to the first weight and the second weight.

20. The non-transitory computer-readable storage medium according to claim 19, wherein determining the network weight includes:
calculating a product of the first weight and the second weight, and determining the product as the network weight between the any two merchants.
